(19) United States
(12) Patent Application Publication
(10) Pub. No.: US 2018/0105892 A9
(43) Pub. Date: Apr. 19, 2018

(54) HOT FORMABLE, AIR HARDENABLE, WELDABLE, STEEL SHEET

(71) Applicants: Farid Eddin Hassani, Crown Point, IN (US); Hyun Jo Jun, Valparaiso, IN (US); Nina Michailovna Fonstein, Chicago, IL (US)

(72) Inventors: Farid Eddin Hassani, Crown Point, IN (US); Hyun Jo Jun, Valparaiso, IN (US); Nina Michailovna Fonstein, Chicago, IL (US)

(21) Appl. No.: 14/615,394

(22) Filed: Feb. 5, 2015

Related U.S. Application Data
(60) Provisional application No. 61/935,948, filed on Feb. 5, 2014.

(51) Int. Cl. C21D 9/46; C21D 6/00; B32B 15/01; C21D 8/02; C22C 38/38; C22C 38/06; C22C 38/24; C22C 38/22; C22C 38/28; C22C 38/26; C22C 38/32

(52) U.S. Cl. CPC C21D 9/46; C21D 2211/008; B32B 15/015; C21D 8/0226; C22C 38/38; C22C 38/06; C21D 8/0263; C22C 38/24; B32B 15/012; C21D 6/002; C22C 38/22; C22C 38/28; C22C 38/26; C22C 38/32; C21D 2211/002; B32B 2311/20; C21D 6/005

(57) ABSTRACT

A steel sheet comprising, in wt %, 0.04≤C≤0.30, 0.5≤Mn≤4, 0≤Cr≤4, 2.7≤Mn+Cr≤5, 0.003≤Nb≤0.1 0.015≤Al≤0.1 and 0.05≤Si≤1.0, has a chemistry that makes hot formed sheet after austenization insensitive to cooling rate and ensures a uniform distribution of tensile strength, in the range of 800-1400 MPa, across parts independent of the time delay between operations and final cooling/quenching. As a result, a formed part can be cooled while inside a die or in air. The addition of Nb reduces the amount of C needed to achieve a given tensile strength and improves weldability.

### CROSS-REFERENCE TO RELATED APPLICATIONS

This application claims the benefit under 35 U.S.C. 119(e) of U.S. Provisional Application No. 61/935,948 filed Feb. 5, 2014.

### FIELD OF THE INVENTION

The present invention relates to steel sheet. In particular, the present invention relates to steel sheet that can be hot formed into parts having uniform, very high tensile strength and high weldability.

### BACKGROUND OF THE INVENTION

Modern vehicles contain an increasing portion of high-strength and ultra-high-strength steels in order to improve passenger safety and reduce vehicle weight. The configuration of many formed vehicle body parts prevents the use of cold formed advanced high-strength steels. As a result, hot forming followed by quenching to a martensite condition has become a popular means for producing ultra-high-strength steel parts.

Special steels are used for hot stamping to ensure necessary hardenability to fit operational parameters. Many of these special steels are designed for quenching in water cooled dies.

An example of such a hot stamping steel is USIBOR, which contains (in % by weight or wt %) 0.15-0.25% C, 0.8-1.5% Mn, 0.1-0.35% Si, 0.01-0.2% Cr, less than 0.1% Ti, less than 0.1% Al, less than 0.05% P, less than 0.03% S, and 0.0005-0.01% B. This chemistry is encompassed by the steel disclosed in U.S. Pat. No. 6,296,805. In this chemistry Ti and B are necessary to achieve high mechanical properties after hot pressing in a water cooled die.

The manufacture of high-strength parts from USIBOR is described in U.S. Pat. No. 6,564,604. The process includes heating hot rolled or cold rolled blanks above 700° C. in a furnace, transferring heated blanks to dies, press forming the blanks in the die and keeping the water cooled die, with the formed blank in it, closed until the part reaches room temperature. Rapid cooling in the water cooled die, i.e. quenching, is necessary to obtain the martensite structure and hence high strength. The quenched steel might have been coated with Zn or Al—Si prior to heat treating for hot stamping via a continuous hot dip coating process to protect the steel substrate from oxidation during hot stamping and from subsequent corrosion attack.

Although USIBOR is widely used for hot stamping and can achieve a tensile strength of 1500 MPa after quenching in a water cooled die, USIBOR has a number of disadvantages. One disadvantage is that USIBOR containing 0.25 wt % C has poor weldability. In addition, the microstructure of USIBOR is highly sensitive to cooling rate and displays ferrite or bainite formation if cooling rates in the water cooled die are slow, hence uniform distribution of strength across hot stamped parts may not be guaranteed. Furthermore, the hot stamping process using USIBOR is generally long and the productivity of the expensive equipment used for hot stamping is relatively low. Moreover, the ductility (e.g, elongation) of USIBOR having a tensile strength greater than 1500 MPa is relatively low.

Air hardening steels are also well known. For example, WO2006/048009 discloses air-hardenable steel containing, in mass %, 0.07-0.15% C, 0.15-0.30% Si, 1.60-2.10% Mn, 0.5-1.0% Cr, 0.30-0.60% Mo, 0.12-0.20% V, 0.010-0.050% Ti and 0.0015-0.0040% B. The steel can be readily welded and galvanized. It exhibits high strength, e.g., a yield strength of 750-850 MPa and a tensile strength of 850-1000 MPa. However, the steel has the disadvantage of using large amounts of expensive elements such as Mo and V.

Patent application publication DE 102 61 210 A1 describes another air-hardenable steel alloy for the production of automobile parts in a hot pressing process. The alloy contains, in mass %, 0.09-0.13% C, 0.15-0.3% Si, 1.1-1.6% Mn, max 0.015% P, max 0.011% S, 1.0-1.6% Cr, 0.3-0.6% Mo, 0.02-0.05% Al and 0.12-0.25% V. When the steel is quenched in a die an upper bainite structure can be obtained without additional quenching. The steel exhibits a yield strength of 750-1100 MPa, a tensile strength of 950-1300 MPa, and an elongation of 7-16%. One disadvantage of this steel is the necessity of using a large amount of expensive Mo and V.

Unexamined Japanese Patent Application No. 2006-213959 provides a method for manufacturing hot press, high-strength, steel members with excellent productivity. The method uses steel sheet that contains, in mass %, 0.05 to 0.35% C, 0.005 to 1.0% Si, 0 to 4.0 Mn, 0 to 3.0% Cr, 0 to 4.0% Cu, 0 to 3.0% Ni, 0.0002 to 0.1% B, 0.001 to 3.0% Ti, ≤0.1% P, ≤0.05% S, 0.005 to 0.1% Al and ≤0.01% N, with the balance Fe and inevitable impurities, where Mn+Cr/3.1+(Cu+Ni)/1.4≥2.5%. The steel sheet is heated at 750-1300° C. for 10-6000 seconds, and then is press-formed at 300° C. or more. After pressing, the molded product is removed from the mold and is cooled from 1200-1100° C. down to 5-40° C. at a cooling speed of 0.1° C./second or more to yield members having a martensite structure of 60% or more in area ratio. By this method, the step of quenching in the press mold can be eliminated. The members obtained have little material quality variation internally, and the shape of the members is good, with excellent uniformity.

Unexamined Japanese Patent Application No. 2006-212663 provides a method of manufacturing hot press high-strength steel members of excellent formability. The method uses steel sheet that contains, in mass %, 0.05 to 0.35% C, 0.005 to 1.0% Si, 0 to 4.0% Mn, 0 to 3.0% Cr, 0 to 4.0% Cu, 0 to 3.0% Ni, 0.0002 to 0.1% B, 0.001 to 3.0% Ti, ≤0.1% P, ≤0.05% S, 0.005 to 0.1% Al and ≤0.01% N, with a balance of Fe and inevitable impurities, where Mn+Cr/3.1+(Cu+Ni)/1.4≥2.5. The steel sheet is heated to 750-1300° C., is kept there for 10-6000 seconds, and then is press-formed two or more times at 300° C. to yield members having a martensite structure of 60% or more in area ratio. The resulting members exhibit high-strength and little variability in internal material quality.

The tensile strength of steel is known to increase with C content. However, an increase in C content decreases weldability.

A need exists for a hot-formable, air-hardenable, high-strength, steel sheet that does not include large amounts of expensive elements, such as Mo, and, in addition to having little internal variability in tensile strength, exhibits excellent weldability.

### SUMMARY OF THE INVENTION

The present invention provides a high tensile strength (800-1400 MPa) steel sheet containing (in wt %) 0.04≤C≤0.30, 0.5≤Mn≤4, 0≤Cr≤4, 2.7≤Mn+Cr≤5, 0.003≤Nb≤0.1, 0.015≤Al≤0.1 and 0.05≤Si≤1.0. Optionally, the steel sheet can contain one or more of Ti≤0.2, V≤0.2, Mo<0.3 and B≤0.015. Following austenization at or above Ac₃+20° C., the steel sheet can be hot formed in a die and can be cooled in the die, or in a cooling medium such as air, nitrogen, oil or water. The chemistry of the steel, particularly the content of Mn+Cr of from 2.7 and 5 wt %, makes the formed sheet insensitive to cooling rate and ensures a uniform distribution of strength across parts independent of the time delay between operations and final cooling/quenching. A Nb content from 0.003 to 0.1 wt % makes the tensile strength less sensitive to the amount of C and reduces the amount of C needed for same tensile strength. Furthermore, since a reduction in C improves weldability, the addition of Nb achieves the same high tensile strength as C alone but with improved weldability. Coating the steel sheet with a coating of Zn, Al or Al alloy can improve the corrosion resistance of the steel sheet.

### BRIEF DESCRIPTION OF THE DRAWINGS

The preferred embodiments of the invention will be described in detail, with reference to the following figures, where:

FIG. 1 shows the change in tensile strength (MPa) with C for various steel sheet compositions when the amount of C ranges from 0.06 to 0.12 wt %, with and without Nb addition;

FIG. 2 shows the change in tensile strength (MPa) with C for various steel sheet compositions when the amount of C ranges from 0.06 to 0.18 wt %, with and without Nb;

FIG. 3 depicts a Continuous Cooling Transformation (CCT) diagram for a steel according to the present invention, plotting cooling curves as temperature in degrees C. vs log of time in seconds:

FIGS. 4a-4d are photomicrographs, taken at varying magnifications, of a steel of the present invention cooled at different cooling rates;

FIG. 5 is a plot of weld current vs sample number for steels of the present invention, the plot specifically shows the non-scatter of expulsion of the steel in spot welding.

FIG. 6 is a collection of four (4) photomicrographs showing, from top to bottom and left to right, a complete spot weld of a steel of the present invention, a higher magnification of the base metal, heat affected zone, and the welded zone of the spot weld.

### DETAILED DESCRIPTION OF PREFERRED EMBODIMENTS

The present invention provides a steel sheet that can be hot formed into a part having a uniform distribution of strength and improved weldability. The steel sheet is a low alloy steel composition and contains, in wt %, 0.04≤C≤0.30, 0.5≤Mn≤4, 0≤Cr≤4, 2.7≤Mn+Cr≤5, 0.003≤Nb≤0.10, 0.015≤Al≤0.1 and 0.05≤Si≤1.0. Optionally, the steel sheet can contain one or more of Ti≤0.2, V≤0.5. Mo<0.6 and B≤0.015. This chemistry makes a sheet that after hot forming is insensitive to cooling rate and ensures a uniform distribution of strength across parts independent of the time delay between operations and final cooling/quenching. The guaranteed uniformity of tensile properties regardless of cooling rate in specific locations of a formed part can substantially increase the productivity of hot forming. Although tensile strength increases with increasing C, the increase in C decreases weldability. However, by substituting a portion of C with Nb the tensile strength increase can be maintained and weldability improved.

The concentrations of the various component elements of the steel sheets of the present invention are limited for the followings reasons. The concentrations are given in weight % (i.e., wt %).

Carbon is essential for increasing the strength of the steel. However, if too much C is added, welding becomes difficult. Thus, the amount of C is limited to the range of from 0.04 to 0.30 wt %. Preferably, the lower limit for the amount of C is 0.06 wt %/o, more preferably 0.08 wt %. Preferably, the upper limit for the amount of C is 0.18 wt %, more preferably 0.16 wt %.

Manganese, besides being a solid solution strengthening elements, also inhibits ferrite transformation, so it is an important chemical element for ensuring quenchability. However, adding too much Mn will not only encourage co-segregation with P and S, but also adversely affect manufacturability during steel making, casting, and hot rolling. Thus, the amount of Mn is limited to the range of from 0.5 to 4 wt %. Preferably, the lower limit for the amount of Mn is 1 wt %, more preferably, 1.5 wt %. Preferably, the upper limit for the amount of Mn is 3.5 wt %, more preferably 3.0 wt %.

Chromium is important for improving quenchability. However, too much Cr will adversely affect manufacturability during manufacturing. Thus, the amount of Cr is limited to the range of from 0 to 4 wt %. Preferably, the lower limit for the amount of Cr is 0.2, more preferably, 0.5 wt %. Preferably, the upper limit for the amount of Cr is 3.5 wt %, more preferably 3.0 wt %.

The combined amount of Mn and Cr is limited to the range of from 2.7 to 5 wt % in order to make the steel insensitive to cooling rate after forming and to ensure a uniform distribution of strength across parts independent of the time delay between operations and final cooling/quenching. Preferably, the lower limit for Mn+Cr is 3.0, more preferably, 3.3 wt %. Preferably, the upper limit for Mn+Cr is 4.7 wt %, more preferably 4.4 wt %.

Previously, small additions of Nb to IISLA steels has been known for its significant effect on preventing austenite recrystallization and hence fine ferrite grain size, as well as precipitation hardening of ferrite by fine carbo-nitrides. Also, larger quantities of Nb have been added to high C creep resistant alloyed steels. However, up to now, the effect of small additions of Nb on low to mid carbon steels with martensitic microstructure has not been reported in open literature. The inventors have discovered that a small addition of Nb to air hardenable the steels of the present invention reduces the sensitivity of tensile strength on the C content, and significantly increases strength of steel, thus reducing the quantity of C needed to achieve a specific tensile strength. Since carbon reduction improves weldability, the addition of Nb helps to achieve the desired high tensile strength with improved weldability. To achieve these effects, the amount of Nb is limited to the range of from 0.003 to 0.1 wt %. Preferably, the lower limit for the amount of Nb is 0.005, more preferably, 0.010 wt %. Preferably, the upper limit for the amount of Nb is 0.09 wt %, more preferably 0.085 wt %.

Al in small amount is added to steel as deoxidizer. However, too much Al results in many nonmetal inclusions and surface blemishes. Al is also a strong ferrite forming element and significantly increases full austenitization temperature. These are undesirable effects for air hardenable steels. Thus, the amount of Al is limited to the range of from 0.015 to 0.1 wt %. Preferably, the lower limit for the amount of Al is 0.02, more preferably, 0.03 wt %. Preferably, the upper limit for the amount of Al is 0.09 wt %, more preferably 0.08 wt %.

Si is effective for increasing the strength of steel sheet. However, too much Si creates a problem of surface scale. Thus, the amount of Si is limited to the range of from 0.05 to 0.35 wt %. Preferably, the lower limit for the amount of Si is 0.07, more preferably, 0.1 wt %. Preferably, the upper limit for the amount of Si is 0.3 wt %, more preferably 0.25 wt %.

Ti can be optionally added to the steel with B in an amount of ≤0.1 wt % to improve quenchability. Ti combines with N at very high temperature, hence preventing BN formation. B in solution improves quenchability. Ti beyond the stoichiometric ratio to nitrogen is a carbide forming element. It strengthen steel by forming very fine carbides. It's effect is similar to Nb.

V can be optionally added to the steel in an amount of ≤0.2 wt % to increase the strength of the steel via fine precipitation. It also adds to hardenability of steel.

Mo can be optionally added to the steel in an amount of ≤0.3 wt % to increase strength and improve quenchability.

B can be optionally added to the steel in an amount of ≤0.005 wt % to increase hardenability and hence strength of the steel.

The steel also contains Fe and can contain unavoidable impurities.

The steel sheet of the present invention has a martensitic microstructure that can include up to 10% lower bainite phase. The microstructure is predominantly martesnite. The amount of bainite can be up to 10%, preferably less than 5% and more preferably less than 1%.

The steel sheet of the present invention has a tensile strength in the range of 800-1400 MPa. The lower limit of the tensile strength is preferably 900 MPa, more preferably 1000 MPa. The final strength depends mostly on carbon content in martensite.

The steel sheet of the present invention can exhibit an elongation in the range of from 4 to 9%, preferably 5 to 9%, more preferably 6 to 9%.

The steel sheet of the present invention can be made by processes that begin with conventional steelmaking and casting processes and then follow with hot rolling. The cast slabs may be charged directly to a reheating furnace before hot rolling or cooled before doing so. There is no restriction on the finishing temperature in the hot rolling process other than that it should be above Ar₃.

The coiling temperature after hot rolling depends on the processing after hot rolling. If cold rolling is required to obtain the final thickness, then a coiling temperature between 700° C. and 600° C. is preferred. If the final required thickness can be obtained directly by hot rolling, then a coiling temperature between 600° C. and 500° C. is recommended.

The hot rolled sheet can be pickled. For cold-rolled products, the hot rolled sheet can be pickled before cold rolling to the required thickness.

The hot rolled or cold rolled steel sheet can be protected from oxidation and/or corrosion by coating one or both sides of the steel sheet with Zn, Al or an Al alloy, such as Al—Si. The coating can be performed by continuously hot dip coating the steel sheet.

Steel sheets with or without coatings are heated to the temperature of full austenitization, i.e., to at least Ac₃+5° C., before being formed, e.g., by stamping, in one or several dies to the shape desired. The hot formed part is then cooled in a die or in a cooling medium such as air, nitrogen, oil or water. Different cooling media provide different cooling rates. The formed parts exhibit uniform martensite structure across the parts regardless of cooling rate.

The final strength can be controlled by the chemistry (in particular, the amounts of C and Nb) and/or by heating below or above the temperature of full austenitization.

### EXAMPLES

50 mm slabs of the chemistries shown in Table 1 were made in laboratory. The slabs were hot rolled to 3.5 mm sheets. The reheating temperature was 1220° C., finishing temperature of 850° C. and coiling temperature of 700° C. The hot rolled sheets were surface ground on both sides to 2.5 mm thickness to remove a decarburized surface layer that would have been caused during the laboratory reheating process. The 2.5 mm sheets were cold rolled to 1 mm (60% cold reduction) in a reversing laboratory cold mill. Specimens from the cold rolled sheets were austenitized at 900° C. for 300 sec in a salt bath and then oil quenched. Some samples were instrumented with a thermocouple to measure the cooling rate during oil quenching. Average cooling rate from 800° C. to 300° C. was 150° C./s. Mechanical properties of quenched samples were measured in transverse to rolling direction. Summary of the mechanical properties are given in Table 2

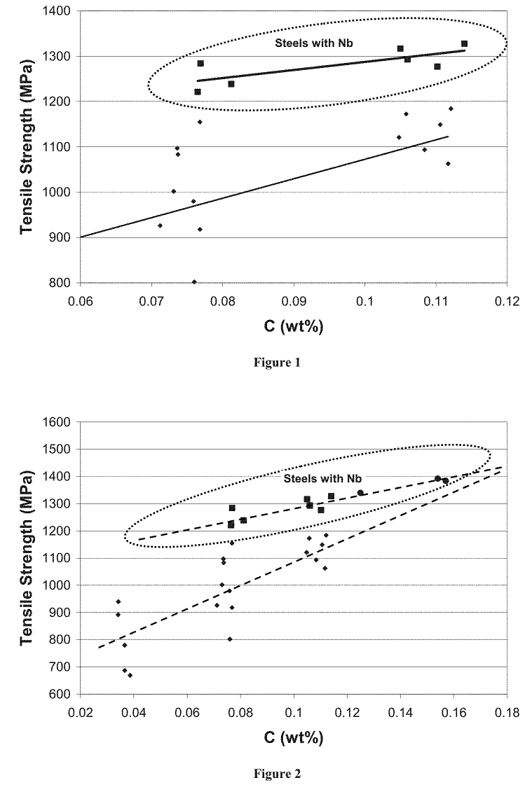

Tensile strength data in Table 2 plotted against carbon in the chemistry, FIG. 1. Tensile strength strongly depends on carbon, as noted by many previous publications (for example see “Martensite transformation, structure and properties in hardenable steels, G. Krauss, Hardenability concepts with applications to steel, D. V. Doane & J. S. Kirkaldy ed., Oct. 24-26, 1977, page 235). However, FIG. 1 also shows that the steels with Nb have higher strength than the steel with similar carbon without Nb. In addition, strength of Nb added steel is less dependent on carbon since slope of the line fitted to the tensile strength of steels with Nb is much less than the one for steels without Nb. The difference in strength of steels with and without Nb becomes less as C is increased and both group of steels have similar strength at 0.17% C and higher, FIG. 2.

To determine effect of cooling rate on final strength of quenched material, “critical cooling rate” i.e., “the minimum cooling rate from austenitization temperature to avoid ferrite” was evaluated. In these experiments, Continuous Cooling Transformation (CCT) diagram of the steel was produced using MMC dilatometer. In these test a small sample was heated to 900° C. and then cooled at pre-determined cooling rates while the sample dilatation (change in length) was measured. Different phase transformations during cooling were identified from the dilatation data as well as by evaluating the microstructure and final hardness of the cooled sample. Several cooling rates are required to construct the CCT diagram.

An example of such diagram is shown in FIG. 3. As it seen from this figure, ferrite transformation does not occur at cooling rates higher than 1° C./sec. Microstructures at 3° C./sec and higher cooling rates shown in Error! Reference source not found. —A & C show a martensitic microstructure. However, there is high degree of tempering at the lower cooling rates, Error! Reference source not found. —B & D. Despite tempering martensite, high hardness of 3501V was obtained at 3° C./sec cooling rate and it increases as the cooling rate increase. Cooling a steel of the present invention in any medium (air, oil, die, nitrogen) which results in cooling rates higher than 1° C./sec or preferably higher than 3° C./sec will produce a fully martensitic—high strength steel.

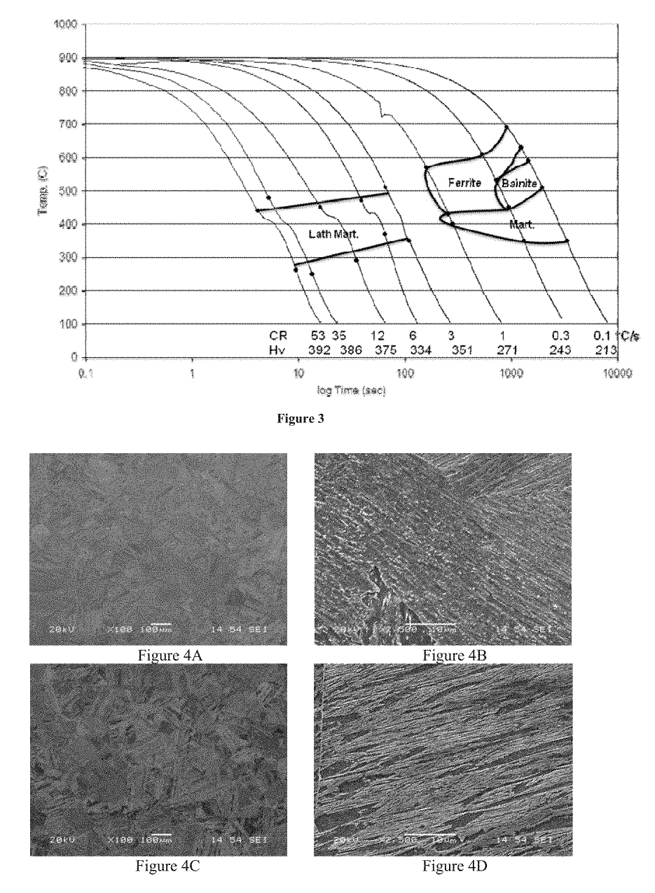

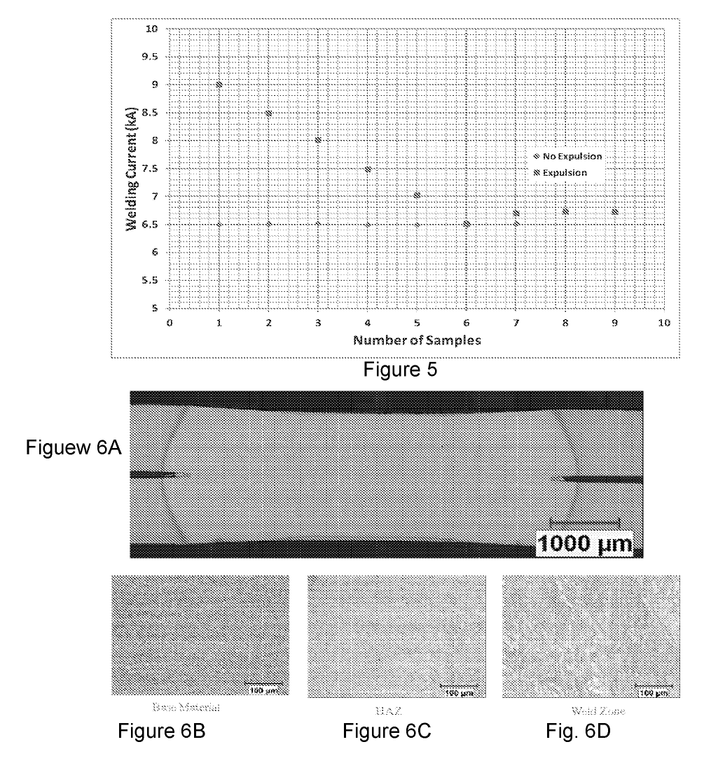

Spot weldability of steels 55, 63, 81 and 141 were evaluated according to ISO18278-2 specification in homogeneous joint configuration. These tests showed non-scattered results under expulsion, FIG. 4, with uniform microstructure of the weld nugget. FIG. 5.

Table 1 and Table 2, FIG. 1 and FIG. 2 show that the same high tensile strength can be obtained when, for a C content ranging from 0.04 to 0.20 wt %, some C is replaced with Nb in amounts ranging from 0.003 to 0.055 wt %.

The disclosure herein of a numerical range is intended to be the disclosure of the endpoints of that numerical range and of every rational number within that numerical range.

While the present invention has been described with respect to specific embodiments, it is not confined to the specific details set forth, but includes various changes and modifications that may suggest themselves to those skilled in the art, all falling within the scope of the invention as defined by the following claims.

TABLE 1

| Steel | C | Mn | Cr | Nb | Tl | V | B | Al | Mo | Mn + Cr |
|---|---|---|---|---|---|---|---|---|---|---|
| 6 | 0.0386 | 1.96 | 1.02 | | | | | 0.032 | | 2.98 |
| 7 | 0.076 | 1.98 | 1.02 | | | | | 0.035 | | 3.01 |
| 8 | 0.1084 | 1.94 | 1.02 | | | | | 0.031 | | 2.96 |
| 10 | 0.0341 | 2.89 | 0.97 | | | | | 0.031 | | 3.85 |
| 11 | 0.0736 | 2.88 | 1.03 | | | | | 0.025 | | 3.91 |
| 12 | 0.1117 | 2.91 | 0.99 | | | | | 0.032 | | 3.91 |
| 14 | 0.0366 | 1.91 | 2.01 | | | | | 0.027 | | 3.92 |
| 15 | 0.0731 | 1.94 | 1.99 | | | | | 0.032 | | 3.93 |
| 16 | 0.1058 | 1.94 | 2.00 | | | | | 0.026 | | 3.94 |
| 19 | 0.0366 | 0.98 | 2.94 | | | | | 0.029 | | 3.93 |
| 20 | 0.0712 | 0.99 | 2.97 | | | | | 0.027 | | 3.96 |
| 21 | 0.1048 | 0.99 | 3.01 | | | | | 0.031 | | 4.00 |
| 22 | 0.0342 | 2.85 | 1.99 | | | | | 0.03 | | 4.84 |
| 52 | 0.0765 | 2.00 | 1.04 | 0.029 | 0.02 | | | 0.046 | | 3.04 |
| 53 | 0.106 | 1.98 | 1.04 | 0.029 | 0.019 | | | 0.052 | | 3.01 |
| 55 | 0.105 | 1.99 | 1.98 | 0.03 | 0.019 | | | 0.034 | | 3.97 |
| 56 | 0.1102 | 1.95 | 2.01 | 0.049 | | | | 0.042 | | 3.96 |
| 57 | 0.1106 | 1.98 | 2.02 | | 0.051 | | | 0.034 | | 4.00 |
| 58 | 0.1121 | 1.97 | 2.02 | | | 0.094 | | 0.034 | | 3.99 |
| 59 | 0.0737 | 1.99 | 1.07 | | 0.029 | | 0.0032 | 0.043 | | 3.05 |
| 61 | 0.0768 | 1.96 | 1.01 | | | | | 0.023 | 0.187 | 2.97 |
| 62 | 0.0759 | 2.98 | | 0.029 | 0.019 | | | 0.042 | | 2.98 |
| 63 | 0.0769 | 4.08 | | 0.03 | 0.019 | | | 0.046 | | 4.08 |
| 64 | 0.114 | 1.99 | 2.07 | 0.049 | | | | 0.038 | | 4.06 |
| 65 | 0.0812 | 3.03 | 1.03 | 0.031 | 0.017 | | | 0.026 | | 4.06 |
| 81 | 0.0768 | | 4.06 | 0.03 | 0.023 | | | 0.018 | | 4.06 |
| 141 | 0.125 | 2.05 | 0.52 | 0.053 | | | | 0.029 | | 2.57 |
| 142 | 0.154 | 2.09 | 1.02 | 0.057 | | | | 0.03 | | 3.10 |
| 143 | 0.157 | 2.07 | 0.52 | 0.052 | | | | 0.026 | | 2.58 |

TABLE 2

| | YS | TS | TE |
|---|---|---|---|
| Steel | (MPa) | (MPa) | (%) |
| 6 | 521 | 669 | 7 |
| 7 | 592 | 802 | 7 |
| 8 | 809 | 1094 | 6 |
| 10 | 695 | 892 | 7 |
| 11 | 832 | 1097 | 6 |
| 12 | 787 | 1063 | 6 |
| 14 | 606 | 780 | 7 |
| 15 | 752 | 1002 | 5 |
| 16 | 862 | 1172 | 7 |
| 19 | 516 | 687 | 8 |
| 20 | 683 | 926 | 7 |
| 21 | 834 | 1121 | 5 |
| 22 | 720 | 940 | 6 |
| 52 | 914 | 1221 | 6 |
| 53 | 959 | 1293 | 7 |
| 55 | 982 | 1317 | 6 |
| 56 | 965 | 1277 | 7 |
| 57 | 841 | 1149 | 6 |
| 58 | 628 | 904 | 9 |
| 59 | 839 | 1083 | 7 |
| 61 | 717 | 918 | 4 |
| 62 | 744 | 980 | 6 |
| 63 | 984 | 1284 | 6 |
| 64 | 988 | 1328 | 6 |
| 65 | 954 | 1239 | 6 |
| 81 | 909 | 1155 | 7 |
| 141 | 1025 | 1340 | 7 |
| 142 | 1004 | 1392 | 7 |
| 143 | 1042 | 1384 | 7 |

What is claimed is:

1. A steel sheet comprising, in weight %,
0.04≤C≤0.30,
0.5≤Mn≤4,
0≤Cr≤4,
2.7≤Mn+Cr≤5,
0.003≤Nb≤0.1,
0.015≤Al≤0.1, and
0.05≤Si≤1.0,
wherein the steel sheet has a tensile strength in the range of 800-1400 MPa.

2. The steel sheet according to claim 1, wherein 0.06≤C≤0.18.

3. The steel sheet according to claim 1, wherein 0.08≤C≤0.16.

4. The steel sheet according to claim 1, wherein 0.2≤Mn≤3.5.

5. The steel sheet according to claim 1, wherein 0.5≤Mn≤3.0.

6. The steel sheet according to claim 1, wherein 0.2≤Cr≤3.5.

7. The steel sheet according to claim 1, wherein 0.5≤Cr≤3.0.

8. The steel sheet according to claim 1, wherein 3.0≤Mn+Cr≤4.7.

9. The steel sheet according to claim 1, wherein 3.3≤Mn+Cr≤4.4.

10. The steel sheet according to claim 1, wherein 0.005≤Nb≤0.060.

11. The steel sheet according to claim 1, wherein 0.010≤Nb≤0.055.

12. The steel sheet according to claim 1, wherein at least one surface of the steel sheet is coated with layer comprising Zn, Al or an Al alloy.

13. The steel sheet according to claim 1, wherein the steel sheet has a microstructure comprising 95 to 100 area % martensite.

14. The steel sheet according to claim 1, wherein the steel sheet has a microstructure comprising 95 to 100 area % bainite.

15. The steel sheet according to claim 1, wherein the steel sheet is a hot formed steel sheet.

16. A method of making a steel sheet, the method comprising hot rolling a steel composition comprising, in weight %,
0.04≤C≤0.20,
0≤Mn≤4,
0≤Cr≤4,
2.7≤Mn+Cr≤5,
0.003≤Nb≤0.055,
0.015≤Al≤0.1, and
0.05≤Si≤0.35; and
producing the steel sheet of claim 1.

17. A method of using a steel sheet, the method comprising hot forming the steel sheet of claim 1.
